(19) United States
(12) Patent Application Publication
(10) Pub. No.: US 2009/0081094 A1
(43) Pub. Date: Mar. 26, 2009

(54) METHOD AND INSTALLATION FOR THE PURIFICATION OF GAS

(76) Inventors: Michael Gaiffi, Horb (DE); Christian Burgbacher, Neckar (DE); Marcel Huber, Flaurling (AT); Christian Roschitz, Koflach (AT); Markus Kleinhappl, Weiz (AT)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/193,893

(22) Filed: Aug. 19, 2008

(30) Foreign Application Priority Data
Aug. 25, 2007 (EP) 07 016 699.6

(51) Int. Cl. B01D 53/52; B01D 53/58

(52) U.S. Cl. 423/220; 423/238; 422/168

(57) ABSTRACT

A method and an installation is provided for the purification of gas, in particular synthesis gas, from the gasification of sewage sludge. Scrubbing hydrogen sulfide and ammonia is performed successively from the gas in two gas scrubbers.

### CROSS-REFERENCE TO RELATED APPLICATION

The present application claims priority under 35 U.S.C. §119 to European Patent Application No. 07 016 699.6, filed on Aug. 25, 2007, the entire disclosure of which is incorporated herein by reference.

### TECHNICAL FIELD OF THE INVENTION

The invention relates to a method and an installation for the purification of gas. Gases, thus a gas mixture, can also be purified. The invention relates in particular to a method and an installation for the purification of so-called synthesis gas or biogas obtained through thermal or biological processing of, in particular, sewage sludge or also other biological substances or renewable raw materials, for example through gasification, pyrolysis or fermentation. The gas is combustible and can be provided for thermal utilization. It can be utilized, for example, for operating a gas engine for power generation or can be burned for heating purposes. The thermal utilization of the purified gas, thus its use for heat and/or power generation for example, must be differentiated from the thermal utilization of the starting materials, such as for example sewage sludge, other biological substances or renewable raw materials for obtaining the gas.

### DESCRIPTION OF THE RELATED ART

Gasification of sewage sludge is known per se. Patent Application EP 1 112 970 A1 discloses a method and an installation for the gasification of sewage sludge. The sewage sludge is placed into a gasifier and there thermally decomposed by heating under a deficiency of air or oxygen. A combustible gas or gas mixture, the synthesis gas, is formed which can be utilized for power and/or heat generation.

The sewage sludge is preferably dried before its gasification, wherein moisture can still be contained in the sewage sludge to be gasified. The sewage sludge is preferably supplied to the gasification in the solid state, for example as a granulate, and not as sludge in the proper meaning of the word. Nevertheless, the material to be gasified will be referred to as sewage sludge in the explanation of the invention.

The synthesis gas obtained through the gasification comprises inter alia tar, ammonia and hydrogen sulfide. To purify the synthesis gas of tar, in the known installation and according to the known method the synthesis gas is cooled to a temperature at which the tar condenses. The synthesis gas is subsequently conducted through the sewage sludge to be gasified, which sludge acts as a filter and purifies the synthesis gas of the tar. The tar filtered out of the synthesis gas, together with the sewage sludge to the gasified, is supplied to the gasifier and is gasified there. In the gasifier the tar is burned, thus supplying heat for the thermal decomposition of the sewage sludge and/or the tar is also decomposed into combustible gas, i.e. synthesis gas.

After the tar has been filtered out of the synthesis gas, ammonia and hydrogen sulfide remain as harmful substances. In thermal utilization of the synthesis gas the ammonia and the hydrogen sulfide will react to form nitrogen and sulfur oxides which, as air pollutants in the waste gas, would in the most favorable case be undesirable and in any case is problematic with respect to emission laws and, in the least favorable case, are impermissible. Sulfur dioxide, in addition, causes considerable corrosion problems such that thermal utilization of the synthesis gas in a gas engine or a gas turbine is virtually impossible.

### SUMMARY OF THE INVENTION

The invention therefore addresses the problem of purifying synthesis gas of ammonia and/or hydrogen sulfide.

According to the invention, ammonia and/or hydrogen sulfide is scrubbed in a gas scrubber, referred to hereinafter as scrubber, using water derived from a gas or gas mixture, in particular the synthesis gas or a biogas. The water for washing the gas is obtained through condensation directly or indirectly from the gas to be purified. In the gas scrubber the gas comes into contact with the water, which dissolves the ammonia and/or the hydrogen sulfide and thereby removes it from the gas, which is referred to as scrubbing. The gas can subsequently be provided for thermal utilization. The water in the gas scrubber is also referred to as scrub water. The water can be liquid or gaseous, the gas can be conducted through a water bath, the water can be distributed as drops or droplets in the air or in another gas, or be dissolved or be gaseous in the form of vapor.

According to an aspect of the invention, a method for the purification of gas is provided. The method includes scrubbing ammonia and/or hydrogen sulfide using condensate obtained directly or indirectly from the gas.

According to an aspect, the hydrogen sulfide is washed out with condensed water that had been obtained from the moist gas through condensation and comprises alkalizing substances, such as, for example, ammonia, which originate from the gas.

According to another aspect, the gas is synthesis gas which had been obtained through thermal processing of biosubstances.

In accordance with another aspect, after the hydrogen sulfide has been scrubbed out of the synthesis gas, it is precipitated from the wash water using a precipitating agent.

According to yet another aspect, the ammonia is scrubbed out of the synthesis gas after the hydrogen sulfide.

In accordance with still another aspect, the wash water is conducted in a cycle.

In still another aspect, the synthesis gas is cooled with water and/or is conducted for purification through sewage sludge before the ammonia and/or the hydrogen sulfide is scrubbed out of the synthesis gas.

According to another aspect, an installation for the purification of gas includes a gas scrubber in which ammonia and/or hydrogen sulfide is scrubbed out of the gas using water.

According to another aspect, the gas scrubber comprises a first gas scrubber for scrubbing the hydrogen sulfide and a second gas scrubber for scrubbing the ammonia out of the synthesis gas.

According to another aspect, the installation includes a condenser which precedes the gas scrubber and in which the synthesis gas is dried before it is conducted through the gas scrubber, and that for scrubbing the hydrogen sulfide out of the synthesis gas, condensed water from the condenser is supplied to the gas scrubber.

In still another aspect, the installation includes a gasifier for obtaining the synthesis gas.

In yet another aspect, the installation includes a water cooler which precedes the gas scrubber and in which water for cooling is supplied to the synthesis gas before the ammonia and/or the hydrogen sulfide is scrubbed out in the gas scrubber.

According to another aspect, the installation includes a sewage sludge tank preceding the gas scrubber and through which the synthesis gas is conducted before it is supplied to the gas scrubber for scrubbing out the ammonia and/or the hydrogen sulfide, and that the sewage sludge tank includes a gas conduit which conducts the synthesis gas through sewage sludge located in the sewage sludge tank when it flows through the sewage sludge tank.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be explained in further detail in conjunction with an embodiment example depicted in the drawings. The two figures show an installation diagram of an installation according to the invention. The figures are to be understood as simplified schematic diagrams, in which:

FIG. 1 illustrates a gas generation part with tar recirculation; and

FIG. 2 illustrates an installation part for the purification of synthesis gas according to the invention.

### DETAILED DESCRIPTION OF THE INVENTION

The invention preferably provides one or a plurality of separate gas scrubbers for scrubbing the ammonia and the hydrogen sulfide. The gas flows sequentially through these scrubbers in such a way that it is successively purified of ammonia and hydrogen sulfide. The sequence of the purification can also be reversed. The invention also includes that, in the case of separate gas scrubbers for the ammonia and the hydrogen sulfide, in the gas scrubber for the hydrogen sulfide, ammonia is also scrubbed out of the gas or conversely.

The invention has the advantage that gas, for example synthesis gas, which has been obtained through gasification in particular of sewage sludge, is purified of the harmful substances ammonia and hydrogen sulfide, possibly also of other harmful substances which are taken up by the wash water during the scrubbing of the gas. The invention considerably decreases the damage to the environment during thermal utilization of the gas. The invention likewise decreases or avoids corrosion problems in downstream machines for thermal utilization in a gas engine or a gas turbine, for example. A further advantage of the invention is an embodiment capability in which virtually all working materials for the purification of the gas can be conducted in a cycle and at least to some extent accumulate during the treatment of the gas and do not need to be externally supplied.

In a preferred embodiment the invention comprises a condenser preceding the scrubber, in which the hydrogen sulfide is scrubbed. The gas flows through the condenser and is cooled to such a point that water dissolved in the gas condenses. The gas in any case has a high moisture content if, before the condenser for condensing tar contained in the gas, it is cooled by injection of water and/or if, for the purpose of filtering, it is conducted through the sewage sludge to be gasified, from which the gas/synthesis gas takes up moisture and in the process dries the sewage sludge. Ammonia of the gas is bound or is partially bound in the water, the water condensed out of the gas has a high pH value of, for example 12 to 13, thus it has alkaline or basic action. The water obtained through condensation from the gas is supplied as wash water to the gas scrubber in which the hydrogen sulfide is scrubbed out of the gas. If the gas in the gas scrubber for the hydrogen sulfide still contains ammonia, which can be assumed, the ammonia can partially be dissolved in the wash water, i.e. partially scrubbed out of the gas. Thereby the pH value of the wash water in the gas scrubber for scrubbing the hydrogen sulfide is increased further.

The solution of the ammonia in the wash water depends on its pH value. Due to the high pH value of the wash water, the hydrogen sulfide has good water solubility, the purification action of the gas from hydrogen sulfide is good.

The wash water of the gas scrubber for scrubbing the hydrogen sulfide out of the gas is preferably conducted in a cycle (recirculated). Since the gas takes up water, if, for example, it is conducted for the purpose of filtering through sewage sludge to be gasified, additional water continuously reaches the gas which must be condensed in order to obtain wash water. For that reason it is normally not necessary to supply wash water. However, excess wash water must be discharged through an overflow. The excess wash water can be supplied to the inflow of a water treatment plant whose sewage sludge is gasified for obtaining the gas. Since water to be treated flowing into a water treatment plant conventionally has a low pH value, a high pH value of the excess wash water from the gas scrubber does no harm, on the contrary, it is desirable. Moreover, ammonia contained in the wash water is removed through biological action.

In order to remove from the wash water the hydrogen sulfide scrubbed from the gas, one embodiment of the invention provides for precipitating the hydrogen sulfide from the wash water using a precipitating agent. The precipitating agent reacts chemically with the hydrogen sulfide; it binds the hydrogen sulfide and the precipitate settles in the base of the gas scrubber. The precipitate is drawn off from time to time or continuously or removed in other ways. It is also conceivable to precipitate and remove from the wash water the hydrogen sulfide outside of the gas scrubber. Suitable precipitating agents are bi- and trivalent iron salts, thus iron(II) and iron(III) chlorides and sulfates, the invention not being limited to either of these precipitating agents. The precipitating agent per se is the sole substance that, for the purification of the synthesis gas according to the invention, must be supplied from the outside and must be removed again.

For scrubbing the ammonia from the gas, preferably water with a pH value of 7 or lower, thus of water with neutral or acidic action, is utilized as the wash water. Common industrial water/tap water with no special quality criteria can be utilized as wash water for scrubbing ammonia from the gas. The wash water for scrubbing ammonia is preferably moved in a cycle (recirculated). Excess wash water is withdrawn; it flows, for example, through an overflow from the gas scrubber for scrubbing ammonia from the gas. Ammonia is readily water-soluble, at least if the wash water does not have a high pH value significantly above 7. The purification action of the gas of ammonia is therefore good. The excess wash water from the gas scrubber for scrubbing the ammonia out of the gas, like the wash water from the gas scrubber for scrubbing out the hydrogen sulfide, can be supplied to an inflow of a water treatment plant.

In principle, the sequence of the purification of the gas is not critical. The ammonia can be scrubbed out first and subsequently the hydrogen sulfide. Preferably, due to its high pH value the water obtained through condensation from the gas is utilized for scrubbing out the hydrogen sulfide. The hydrogen sulfide and subsequently the (residual) ammonia is preferably scrubbed out of the gas. The reason is that a portion of the ammonia, still contained in the gas after the condensation, is dissolved with the wash water in the gas scrubber for scrubbing out the hydrogen sulfide, i.e. it is simultaneously scrubbed out if the pH value of the wash water is not too high. The ammonia simultaneously scrubbed in the gas scrubber for scrubbing the hydrogen sulfide out of the gas with scrubbed-out ammonia increases the pH value of the wash water, whereby the purification and scrubbing action for the hydrogen sulfide is increased. Through the circulation (recirculation) of the wash water, the pH value increases further and improves the purification action during the scrubbing of the hydrogen sulfide. The ammonia still remaining in the gas after the scrubbing of the hydrogen sulfide is scrubbed out in the succeeding gas scrubber, whose wash water has a pH value of 7 or lower.

The gas is preferably purified of tar before it is supplied to the condenser for obtaining the wash water, and to the gas scrubber(s) for the purification from ammonia and hydrogen sulfide. For this purpose, according to one embodiment of the invention, the gas is cooled to a temperature at which the tar contained in the gas condenses and the water is dissolved in the gas and remains dissolved. For its purification, the gas is conducted through sewage sludge to be gasified, which sludge acts as a filter and filters the tar out of the gas. By purifying the gas of tar, succeeding installation parts, namely the condenser and the gas scrubber(s) are not loaded with tar and contaminated.

The invention is intended for the purification of synthesis gas obtained through the gasification of sewage sludge. The invention is, nevertheless, also suitable for the purification of combustible gases/synthesis gases obtained through the gasification of gasifiable materials other than sewage sludge, such as for example other biomasses. Gases, other than those obtained by gasification, can also be purified of ammonia and/or hydrogen sulfide using the method according to the invention and the installation according to the invention. The gases can, for example, be obtained through thermal or biological processing, such as, for example, said gasification, through pyrolysis or fermentation.

The gasification of sewage sludge and the purification of the combustible synthesis gas obtained thereby, to which the invention relates in particular, is chosen as an example. However, the invention is not limited to this application, rather it is also suitable for the purification of other gases, which are obtained in particular through thermal or biological processing.

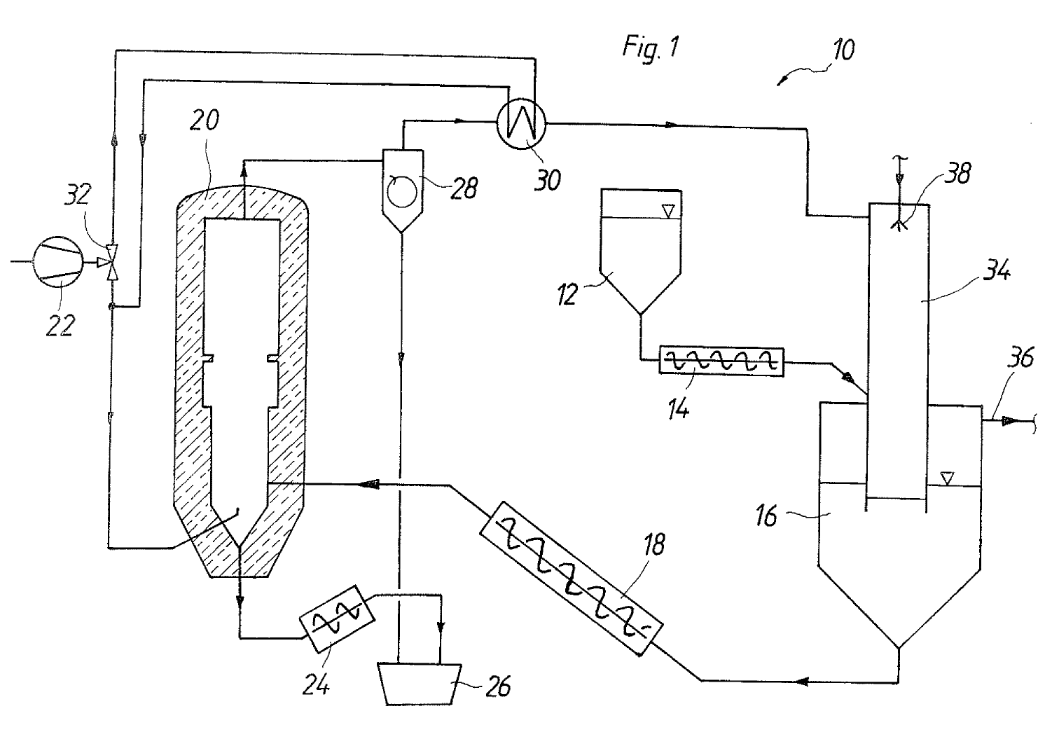

An installation 10 according to the invention and depicted in FIG. 1 serves for obtaining combustible gas from sewage sludge. The combustible gas obtained through gasification is referred to in the following as synthesis gas. The sewage sludge to be gasified is stored as dried sewage sludge granulate in a sewage sludge receiver silo 12. From the sewage sludge receiver silo 12 the sewage sludge granulate is supplied to a sewage sludge tank 16 using a screw feeder 14. A further screw feeder 18 transports the sewage sludge granulate from the sewage sludge tank 16 to a gasifier 20 where the sewage sludge granulate is gasified. Gasification takes place in a manner known per se, for example, from wood gasification. The gasifier 20 is structured as a so-called fluidized bed gasifier, to the lower region of which the sewage sludge granulate is supplied. The air necessary for the gasification is supplied by a blower 22, which blows the air from below into the gasifier 20 and thereby generates the fluidized bed. The sewage sludge granulate is thermally decomposed under air deficiency into a combustible gas or gas mixture, the synthesis gas.

Thermally nondegradable components (ash) of the sewage sludge granulate settle out of the gasifier 20 and are transported with a screw feeder 24 into an ash bin 26.

The combustible synthesis gas escapes at the top of the gasifier 20 and is initially supplied to a cyclone separator 28 in which dust particles are removed. The eliminated dust particles are also conducted into the ash bin 26. The synthesis gas obtained through the thermal decomposition is conducted from the cyclone separator 28 into a cooler (recuperator) 30 in which it is cooled to a temperature of, for example, 770° C. At the outlet of the gasifier 20 the gas has a temperature of, for example, approximately 1100° C. Cooling of the combustible gas in the recuperator 30 is carried out using air, and specifically the air that is drawn in by the blower 22 and supplied to the gasifier 20 for the thermal decomposition of the sewage sludge granulate. In this way the air supplied to the gasifier 20 is preheated in the recuperator 30. Using a three-way stopcock 32, the air drawn in by the blower 22 can optionally be conducted first through the recuperator 30 before it reaches the gasifier 20, or the air can be supplied directly by the blower 22 to the gasifier 20. It is also possible using the three-way stopcock 32 to supply a portion of the air drawn in by the blower 22 to the recuperator 30 and the remaining portion of the drawn-in air to the gasifier 20 directly. Thus the ratio of the air supplied through the recuperator 30 to the gasifier to the air supplied directly to the gasifier 20 can be adjusted, and in this way also the cooling power of recuperator 30 and therewith the exit temperature of the synthesis gas, obtained in the gasifier 20, at the outlet of the recuperator 30.

Following the recuperator 30 the synthesis gas obtained through the thermal decomposition is supplied to the sewage sludge tank 16. The sewage sludge tank 16 comprises a gas cooler 34, which, in the depicted and describe embodiment example, is tubularly formed and standing upright. The gas cooler 34 dips into the sewage sludge granulate contained in the sewage sludge tank 16 such that the synthesis gas supplied to the gas cooler 34 in its upper region must necessarily penetrate through the sewage sludge granulate before it exits from the sewage sludge tank 16 at a gas outlet 36.

To cool the synthesis gas, water is injected into the gas cooler 34 through one or a plurality of water nozzles 38. The water is preferably demineralized. The injected water cools the synthesis gas and is dissolved in the synthesis gas. A sufficient quantity of water is injected into the gas cooler 34 for the synthesis gas to have a temperature of, for example, 120° C. at the gas outlet 36 from the sewage sludge tank 16, such that the water remains dissolved in the synthesis gas. Through the cooling of the synthesis gas in gas cooler 34, the tar contained in the obtained synthesis gas condenses and is filtered in the sewage sludge granulate contained in the sewage sludge tank 16, through which granulate the synthesis gas is conducted. The sewage sludge tank 16 consequently forms a filter and the sewage sludge granulate a filter medium, with which tar contained in the synthesis gas obtained through the thermal decomposition is filtered out of the synthesis gas.

The filtered-out tar, together with the sewage sludge granulate, is fed to the gasifier 20. In the gasifier 20 the tar is burned and thereby increases the efficiency of the gasifier 20, and/or the tar is thermally decomposed to combustible synthesis gas and leaves the gasifier 20 together with the combustible gas obtained through the thermal decomposition of the sewage sludge granulate. The installation 10 according to the invention for synthesis gas obtained from sewage sludge consequently has a tar recirculation. It has the advantage that the tar accumulating in the thermal decomposition of the sewage sludge does not need to be separated and eliminated and does not need to be disposed of, yet it does not load the synthesis gas.

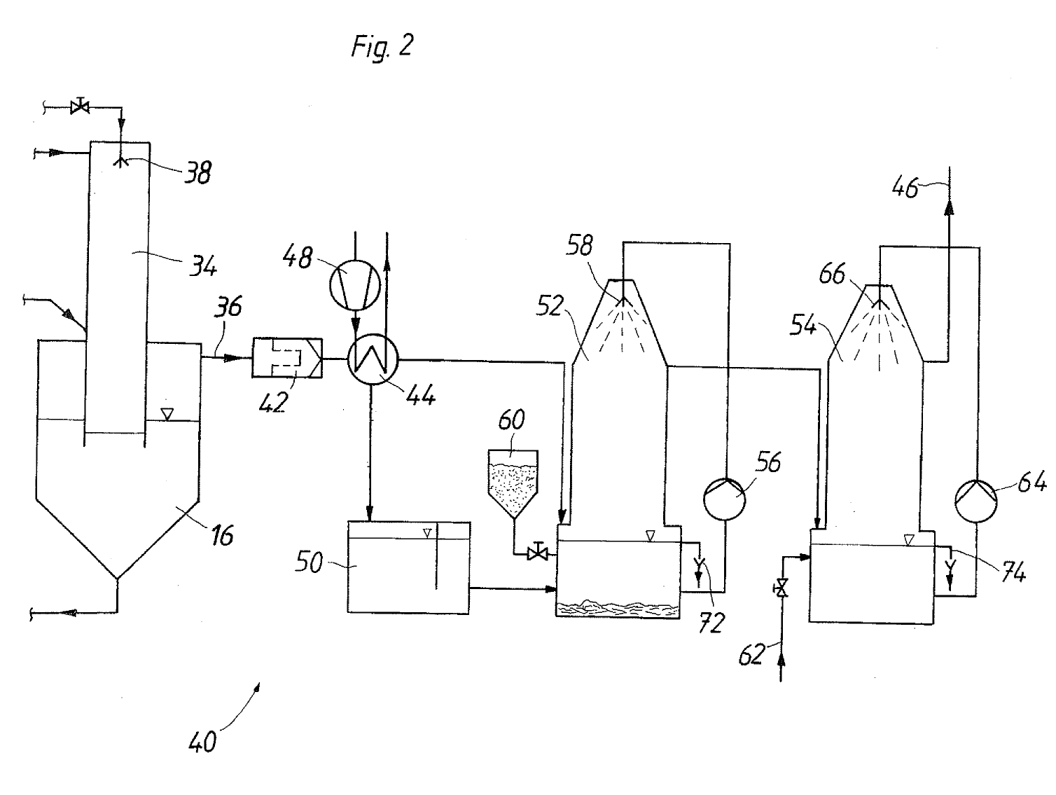

For the purification of the synthesis gas, the installation 10 according to the invention has a water circulation 40 depicted in FIG. 2. The water injected into the gas cooler 34 is dissolved in the synthesis gas and leaves the sewage sludge tank 16, dissolved in the synthesis gas, at the gas outlet 36, after it has been conducted through the sewage sludge granulate contained in the -sewage sludge tank 16. As stated, the synthesis gas at the gas outlet 36 from the sewage sludge tank 16 has a temperature of, for example, 120° C., thus a temperature at which the water injected into the gas cooler 34 remains dissolved. During the conduction of the synthesis gas through the sewage sludge granulate contained in the sewage sludge tank 16, the synthesis gas additionally takes up water which is contained in the form of moisture in the sewage sludge granulate. The synthesis gas obtained through the thermal decomposition during its penetration dries the sewage sludge granulate contained in the sewage sludge tank 16.

After it leaves the sewage sludge tank 16, the synthesis gas is conducted through a filter 42 and subsequently through a condenser 44 and through two scrubbers 52, 54 in which it is purified. After the second scrubber 54, the synthesis gas is provided for utilization (at 46). The synthesis gas can, for example, be supplied for power generation to a (not shown) gas engine or for heat generation to a (not shown) gas burner.

Cooling the condenser 44 is carried out with air which is supplied to the condenser 44 by a blower 48. The water dissolved in the synthesis gas condenses in the condenser 44 and is conducted to an oil separator 50. The condenser 44 separates the water dissolved in the synthesis gas, and thus forms a water separator 44.

The water separated out of the synthesis gas is supplied from the oil separator 50 to the first of the two scrubbers 52. It collects in its base or sump. A pump 56 transports the water from the base upward into a top of the scrubber 52, where it is injected into the scrubber 52 through one or more nozzles 58. On a contact passage between the top and the base of scrubber 52 the water comes into contact with the synthesis gas from condenser 44 which enters the scrubber 52 in the base region, flows upwardly from below through the contact passage counter to the injected water and leaves the scrubber 52 at the top.

The water condensed in the condenser 44 and separated out of the synthesis gas conventionally comprises ammonia and conventionally has a high pH value, thus has alkaline or basic action. Due to the high pH value, the water in the scrubber 52 dissolves hydrogen sulfide from the synthesis gas, the hydrogen sulfide is scrubbed out of the synthesis gas or the synthesis gas is purified of hydrogen sulfide. If the pH value of the water, also referred to as wash water, injected into the scrubber 52 is not too high, ammonia from the synthesis gas is also dissolved in the water and increases its pH value such that the water in the first scrubber 52 has a pH value of, for example, 12 to 13. Due to the high pH value of the wash water in the first scrubber 52, the hydrogen sulfide is readily soluble and the scrubber 52 has good purification action.

In the base of scrubber 52 the hydrogen sulfide is precipitated out of the water, also to be referred to as wash water. The precipitating agent is stored in a silo 60, from which it is supplied to the base of scrubber 52 when needed. As precipitating agents, for example, bi- and trivalent salts of iron, for example iron(II) chloride (FeCl₂), iron(II) sulfate (FeSO₄), iron(III) chloride (FeCl₃) or iron(III) chloride sulfate (FeClSO₄) can be utilized. The precipitating agent is per se the sole foreign substance which must be supplied externally to the purification according to the invention of synthesis gas and is not recirculated. The precipitating agent is drawn off and removed from the base of the scrubber 52 from time to time or continuously.

From the top of the first scrubber 52 the synthesis gas is supplied to the second scrubber 54 at its base. It flows again through a contact passage from the base to the top of scrubber 54, thus from below upwardly, and leaves the scrubber 54 at its top. To the second scrubber 54 water, for example, industrial water is supplied through a line 58 into its base. The water, here again to be referred to as wash water, in the second scrubber 54 has a pH value of 7 or lower, i.e. it has neutral or acidic action. A pump 64 conducts the water from the base of the second scrubber 54 into its top where it is injected through one or several nozzles 66. Due to the pH value of 7 or lower, the water in the second scrubber 54 dissolves the ammonia from the synthesis gas to the extent it has not already been dissolved and scrubbed out in the first scrubber 52. The ammonia still contained in the synthesis gas after the first scrubber 52 and supplied to the second scrubber 54 can also be referred to as residual ammonia. As stated, it is washed out of the synthesis gas in the second scrubber 54, i.e. the synthesis gas is purified of ammonia. The purified synthesis gas leaves the second scrubber 54 at the top and is provided for utilization (at 46).

The wash water of both scrubbers 52, 54 is conducted, as described, in a cycle (recirculated), it is drawn in by a pump 56, 64 out of the base of scrubber 52, 54 and is injected again into the top by nozzles 58, 66 into scrubber 52, 54, from whence it flows again downwardly through the contact passage into the base of scrubber 52, 54. Through the recirculation the wash water in the first scrubber 52 additionally dissolves ammonia and thereby increases its pH value whereby its purification action for hydrogen sulfide increases.

In gas cooler 34 the water injected through nozzle 38 is, as described, dissolved in the synthesis gas, which had been obtained in gasifier 20 through the gasification of the sewage sludge granulate. From the sewage sludge tank 16 the synthesis gas with the dissolved water is conducted into condenser 44, where the dissolved water condenses and is separated. From the condenser 44, as described, the synthesis gas flows into the first scrubber 52 and the separated water, first, separately from the synthesis gas, reaches the oil separator 50 and from it arrives in the base of the first scrubber 52.

Excess water flows out through overflows 72, 74 at the bases of the scrubbers 52, 54. It can be supplied to an inflow of a water treatment plant whose sewage sludge, for example, using the installation according to the invention, is gasified and the synthesis gas purified. Ammonia dissolved in the water is biologically degraded in the water treatment plant. Since water to be treated flowing into water treatment plants conventionally has a low pH value of less than 7, a high pH value of above 7 in the water does not harm the overflows 72, 74 of the scrubbers 52, 54.

The quantities of water, furthermore, are also small.

Since the synthesis gas for the purification of tar is conducted through the sewage sludge granulate in the sewage sludge tank 16 and there takes up water, water is supplied to the water in the water circulation 40, which, in the end leaves through the overflows 72, 74 of the scrubbers 52, 54. Should there be a deficiency of water in the water circulation 40, it can be replenished through line 62 which leads to the base of the second scrubber 54.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A method for the purification of gas, wherein ammonia and/or hydrogen sulfide is scrubbed using condensate obtained directly or indirectly from the gas.

2. The method of claim 1, wherein the hydrogen sulfide is washed out with condensed water that had been obtained from the moist gas through condensation and comprises alkalizing substances, such as, for example, ammonia, which originate from the gas.

3. The method of claim 1, wherein the gas is synthesis gas which had been obtained through thermal processing of biosubstances.

4. The method of claim 1, wherein after the hydrogen sulfide has been scrubbed out of the synthesis gas, it is precipitated from the wash water using a precipitating agent.

5. The method of claim 1, wherein the ammonia is scrubbed out of the synthesis gas after the hydrogen sulfide.

6. The method of claim 1, wherein the wash water is conducted in a cycle.

7. The method of claim 1, wherein the synthesis gas is cooled with water and/or is conducted for purification through sewage sludge before the ammonia and/or the hydrogen sulfide is scrubbed out of the synthesis gas.

8. An installation for the purification of gas, comprising a gas scrubber in which ammonia and/or hydrogen sulfide is scrubbed out of the gas using water.

9. The installation of claim 8, wherein the gas scrubber comprises a first gas scrubber for scrubbing the hydrogen sulfide and a second gas scrubber for scrubbing the ammonia out of the synthesis gas.

10. The installation of claim 8, wherein the installation comprises a condenser which precedes the gas scrubber and in which the synthesis gas is dried before it is conducted through the gas scrubber, and that for scrubbing the hydrogen sulfide out of the synthesis gas, condensed water from the condenser is supplied to the gas scrubber.

11. The installation of claim 8, wherein the installation comprises a gasifier for obtaining the synthesis gas.

12. The installation of claim 8, wherein the installation comprises a water cooler which precedes the gas scrubber and in which water for cooling is supplied to the synthesis gas before the ammonia and/or the hydrogen sulfide is scrubbed out in the gas scrubber.

13. The Installation of claim 8, wherein the installation comprises a sewage sludge tank preceding the gas scrubber and through which the synthesis gas is conducted before it is supplied to the gas scrubber for scrubbing out the ammonia and/or the hydrogen sulfide, and that the sewage sludge tank includes a gas conduit which conducts the synthesis gas through sewage sludge located in the sewage sludge tank when it flows through the sewage sludge tank.
